(19) United States
(12) Patent Application Publication
(10) Pub. No.: US 2012/0324708 A1
(43) Pub. Date: Dec. 27, 2012

(54) METHOD AND SYSTEM FOR A MODULAR CONNECTOR

(75) Inventor: Vitali Minin, Mevaseret Zion (IL)

(73) Assignee: PLASTOKIT QUALITY LTD., KIRYAT MALACHI (IL)

(21) Appl. No.: 13/582,424

(22) PCT Filed: Mar. 1, 2011
(86) PCT No.: PCT/IB11/50856

§ 371 Date: Sep. 2, 2012

Related U.S. Application Data
(60) Provisional application No. 61/312,682, filed on Mar. 11, 2010.

(51) Int. Cl. F16B 17/00; B23P 11/00

(52) U.S. Cl. 29/525.01; 403/292

(57) ABSTRACT

It is provided a plugging port for connecting an element to a receiving port of an article in a releasable manner. The plugging port includes a flat portion projected from a body part of the element, two thickened guiding portions, and an elongated boss structure projecting from the flat portion. The flat portion has two parallel borders of certain length and an external border perpendicular to the two parallel borders. The two thickened guiding portions are connected respectively to the two parallel borders, each guiding portion extending parallel to the respective connected border. The elongated boss structure extends parallel to the external border.

### BACKGROUND OF THE INVENTION

1. Field of the Invention

The invention is in the field of toys, and especially deals with modular connectors for connecting toy elements in a variety of possibilities.

2. Description of Related Art

Toy systems having a plurality of toy pieces for assembling use a variety of connecting methods. Usually, a feature in a toy piece enables to connect it to other pieces. Such a feature enables connection in one or more predetermined configurations while other configurations are not allowed. It is an objective of the present invention to provide a connector, or a connecting piece, used especially for connecting toy pieces such that more configurations and modularity become possible.

It should be noted that toy pieces are used throughout the disclosure as an exemplary use of the disclosed connector, without any intention to limit the connector to toy system. The disclosed connectors may be useful for a broad range of other application and industries, clothing, equipping, packing, for example only.

### BRIEF SUMMARY OF THE INVENTION

It is disclosed according to some embodiments of the current invention, a plugging port for connecting an element to a receiving port of an article in a releasable manner. The plugging port includes a flat portion projected from a body part of the element, two thickened guiding portions, and an elongated boss structure projecting from the flat portion. The flat portion has two parallel borders of certain length and an external border perpendicular to the two parallel borders. The two thickened guiding portions are connected respectively to the two parallel borders, each guiding portion extending parallel to the respective connected border. The elongated boss structure extends parallel to the external border.

The plugging port is inserted in the receiving portion of the article, such that the two thickened guiding portions and the flat portion accommodate respective grooves in the receiving port. The elongated boss is locked into a locking slot therein in a releasable manner.

In some embodiments, the plugging port further includes a gap within the flat portion for facilitating manipulating of the plugging port.

In some embodiments, the two thickened guiding portions are connected to the flat portion by respective tabs, whereas each tab has a width smaller than the length of the respective connected border.

In some embodiments, thickness of the flat portion at the external border is smaller than thickness of the flat portion in some other place.

In some embodiments, the elongated boss structure has a trimmed radial cross-section extending substantially uniformly from end to end.

In some embodiments, the body part of the element is a connector connecting the plugging port to identical plugging ports. Preferably, the connector connects plugging ports such that their fiat portions are perpendicular to a common plane. More preferably, two plugging ports extend outwards in a mutual angular deviation between 40° and 170°.

In some embodiments, the connector connects two plugging ports such that their fiat portions deviate or are able to deviate from perpendicularity to a common plane.

In some embodiments, the connector connects three or four or more plugging ports.

It is disclosed according to some embodiments of the current invention, a receiving port for connecting an article to a plugging port of an element in a releasable manner. The receiving port includes two mutually parallel channels having respective side slots facing each other, a flat space between the channels and a flexible locking edge. The two parallel channels are spaced apart and shaped for receiving two thickened guiding portions of the plugging port. The flat space is configured for accommodating a flat portion of the plugging port. The flexible locking edge is configured for fixing an elongated boss structure of the plugging port in a locking slot inside the receiving port.

By applying certain force for drawing apart a plugged plugging port from the receiving port, the locking edge is displaced such as to release the elongated boss structure from the locking position, thereby letting the plugging port to get out the receiving port.

An article may have two, three or four such receiving ports.

It is disclosed according to some embodiments of the current invention, a method for interaction of an element having plugging ports and an article having a receiving port. The method includes a step of pushing the article towards the element for connecting the element to the article, and a step of drawing the element apart from the article for disconnecting them. The step of pushing the article towards the element includes inserting two parallel thickened guiding portions of the element into respective two mutually parallel channels such that a flat portion of the plugging port between the two parallel thickened guiding portions accommodates a flat space between the channels. Pushing further causes an elongated boss structure of the plugging port to deflect a flexible locking edge of the receiving port and thus to accommodate a locking slot inside the receiving port.

The step of drawing apart the element from the article includes causing the elongated boss structure of the plugging port to deflect the flexible locking edge of the receiving port and thus get out of the locking position. Drawing apart also causes the two parallel thickened guiding portions to get out from the respective channels, such that the flat portion of the plugging part gets out the flat space.

Preferably, the element and the article are building blocks of a modular toy set, and the method is used to assemble and disassemble the toy set.

It is disclosed according to some embodiments of the current invention, a connector having several plugging ports for connecting, in a releasable manner, several articles having receiving ports. A plugging port of the connector includes a flat portion, an elongated boss structure, and a gap. The flat portion has two parallel borders and an external border perpendicular to them. The elongated boss structure projects from the flat portion and extends parallel to the external border. The gap is placed within the flat portion, and is configured for facilitating manipulating of the plugging port.

The plugging port is inserted in a receiving portion of an article, such that the flat portion accommodates respective groove in the receiving port, and the elongated boss is locked into a locking slot therein in a releasable manner. Preferably, the connector connects plugging ports such that their flat portions are perpendicular to a common plane.

In some embodiment, the flat portions are mutually perpendicular.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1a is a perspective view of an element having a plugging port.

FIG. 1b is a side view of the element having a plugging port of FIG. 1a.

FIG. 2a is a perspective view of a double port connector.

FIG. 2b is a side view of the double port connector of FIG. 2a.

FIG. 3a illustrates two pathway segments of a modular pathway toy set with a double port connector plugged inside one segment.

FIG. 3b illustrates the two pathway segments connected by the double port connector plugged inside the two segments out of sight.

FIG. 4a is a sectional isometric view of the double port connector with a plugging port plugged inside a receiving port.

FIG. 4b is a sectional side view of the double port connector outside the receiving port.

FIG. 4c is a sectional side view of the double port connector plugged inside the receiving port.

FIG. 5 is a flow chart of a method for manipulating a modular toy set.

FIG. 6a is a perspective view of a double port connector having an acute angle between the flat portions of the two plugging ports.

FIG. 6b is a side view of a double port connector having an acute angle between the flat portions of the two plugging ports.

FIG. 6c is a side view of a double port connector having an obtuse angle between the flat portions of the two plugging ports.

FIG. 6d is a side view of a double port connector having a right angle between the flat portions of the two plugging ports.

FIG. 7a is a side view of a T-shaped triple port connector.

FIG. 7b is a side view of a cross shaped four port connecter.

FIG. 7c is a side view of a triple port connector having an angle of 120° between the flat portions of each two ports.

FIG. 8 illustrate a double port connector having flat portions that deviate or are able to deviate from perpendicularity to a common plane.

FIG. 9a is a perspective view of a double port connector having at each port an elongated boss structure and a gap.

FIG. 9b is a side view of the double port connector of FIG. 9a.

FIG. 10 illustrates a double port connector having a round external border.

FIG. 11a depicts a T-shaped triple port connector with round external borders.

FIG. 11b depicts a cross shaped four port connector with round external border.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described devices is necessary to implement the invention as claimed in any particular, one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

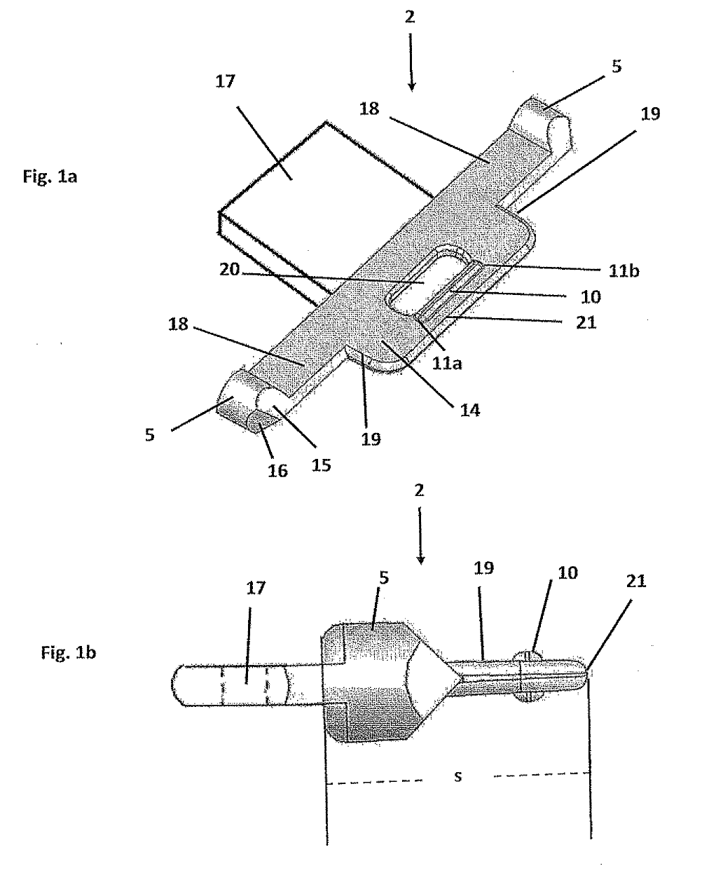

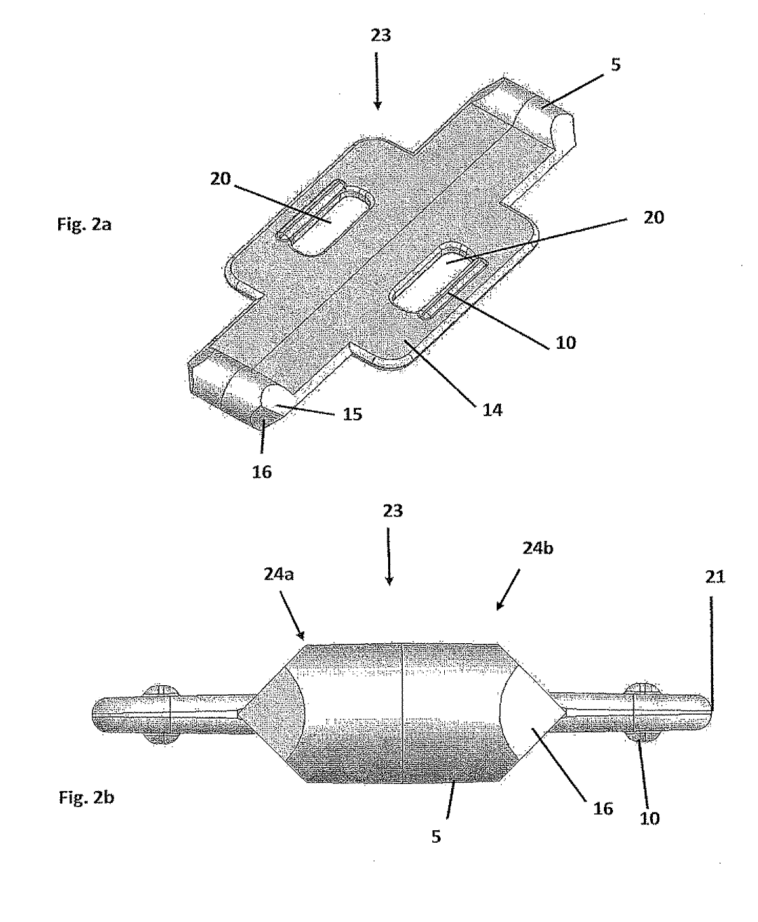

### A Single Port Connector and a Double Port Connector (FIG. 1-2)

In one embodiment of the disclosed invention, illustrated in the perspective view of FIG. 1a and in the side view of FIG. 1b, a plugging port for connecting an element 2 to a receiving port of an article in a releasable manner is presented. The plugging port includes a flat portion 14 projected from a body part 17 of element 2, two thickened guiding portions 5, and an elongated boss structure 10 projecting from flat portion 14. Flat portion 14 has two parallel borders 19 of certain length s and an external border 21 perpendicular to two parallel borders 19. Two thickened guiding portions 5 are connected respectively to two parallel borders 19, each guiding portion 5 extending parallel to the respective connected border 19. Elongated boss structure 10 extends parallel to external border 21.

The plugging port is inserted in the receiving portion of the article, such that two thickened guiding portions 5 and flat portion 14 accommodate respective grooves in the receiving port. Preferably, the incoming edge of guiding portion 5 includes two slops 15 and 16 enabling forced insertion of guiding portions 5 inside the corresponding grooves of the receiving port, even while overcoming some tightness. That tightness helps keeping the plugging port in place after insertion and necessitates some force to separate the plugging port from the receiving port. Elongated boss 10 is locked into a locking element in the receiving port in a releasable manner.

In the embodiment of FIG. 1, two thickened guiding portions 5 are connected to flat portion 14 by respective tabs 18 whereas each tab 18 has a width, in parallel to respective connected border 19, which is smaller than the length s of border 19.

Thickness of the flat portion at is smallest at external border 21, as shown in FIG. 1b, and the thickness grows towards body 17.

Elongated boss structure 10 is shown in FIGS. 1a and 1b to have a trimmed radial cross-section extending substantially uniformly from end 11a to end 11b. The locking element in the receiving port may be shaped as a slot adapted for receiving boss structure 10. In other embodiments, boss structure 10 may have a non uniform cross-section in accordance with the shape of a locking element of the receiving port.

For facilitating modular construction of a toy set, there is provided a connecting element or connector 23 having plugging ports 24a and 24b directly coupled to one another, as illustrated in the perspective view of FIG. 2a and in the side view of FIG. 2b. Plugging ports 24a and 24b are identical to each other and to the plugging port of FIG. 1.

Plugging ports 24a and 24b include gaps 20 within flat portion 14 to enable drawing connector 23 out a receiving port while one plugging port is plugged inside the receiving port. Using gap 20, connector 23 may be grasped manually or be manipulated by an extractor (not shown).

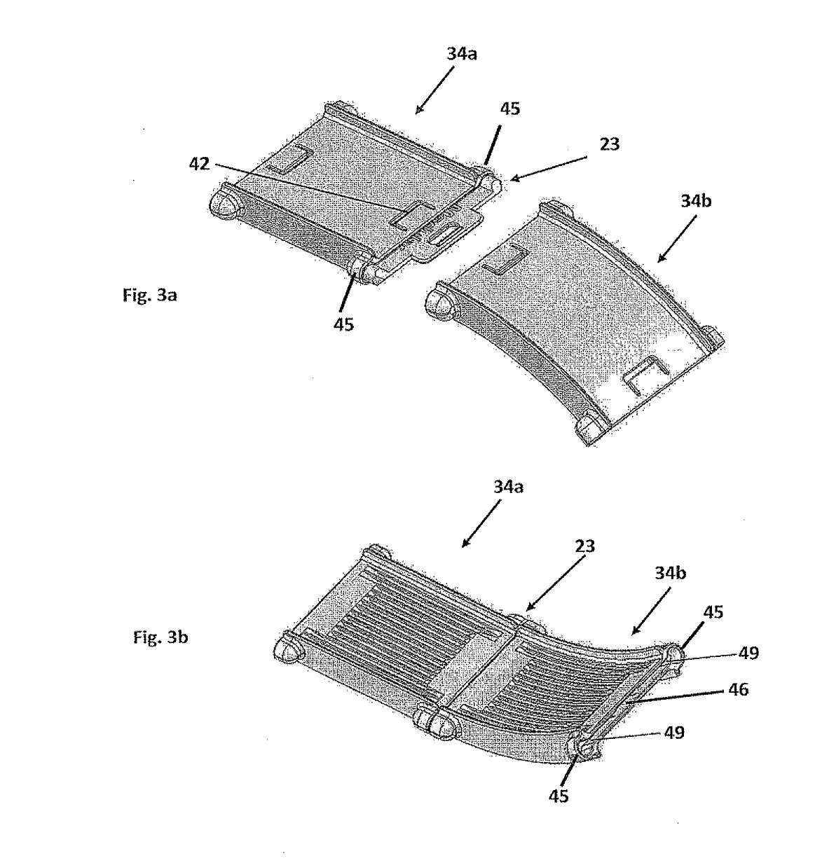

### Connecting Building Blocks Using Receiving and Plugging Ports (FIGS. 3-5)

FIGS. 3a and 3b present an example of two pathway segments 34a and 34b of an exemplary pathway construction set, and a double port connector 23. Each of pathway segments 34a and 34b has two receiving ports for receiving plugging ports. FIG. 3a illustrates pathway segments 34a and 34b with one plugging port of connector 23 plugged inside segment 34a. FIG. 3b is illustrates pathway segments 34a and 34b connected by double port connector 23 plugged inside the two segments, whereas connector 23 is out of sight (not shown). Each receiving port includes two mutually parallel channels 45 which are spaced apart and have respective side slots 49 facing each other, a flat space 46 between channels 45, and a flexible locking edge 42.

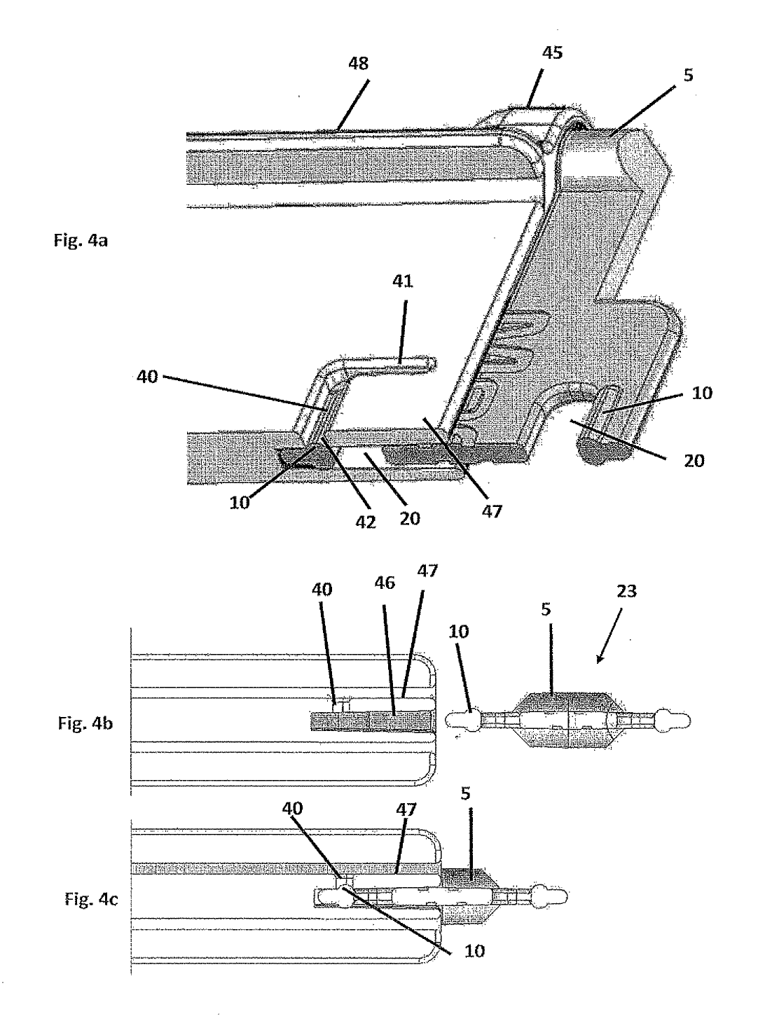

Referring now to the sectional drawing of FIG. 4a, and to the side views of FIG. 4b and FIG. 4c, each of parallel channels 45 has a substantially circular cross-section, shaped for receiving a respective guiding rod-like portion 5 of plugging port 24a. Flat space 46 is bounded by two parallel planes such that it accommodates a flat portion 14 of plugging port 24a. Flexible locking edge 42 is configured for fixing an elongated boss structure 10 of plugging port 24a in a locking slot 40 inside the receiving port.

For the sake of flexibility, locking edge 42 is part of a tab 47. The disconnection of tab 47 from the body of pathway segment 34a by slot 40 and by slots 41 allows edge 42 to be displaced slightly and allow boss 10 slide into slot 40.

By applying certain force for drawing apart plugged plugging port 24a from the receiving port, locking edge 42 is displaced slightly, releasing elongated boss structure 10 from its locking position at slot 40, thereby letting plugging port 24a to get out the receiving port.

For drawing plugging port 24a from pathway segment 34a, a player may use a gap 20 of plugging port 24b to grasp double port connector 23.

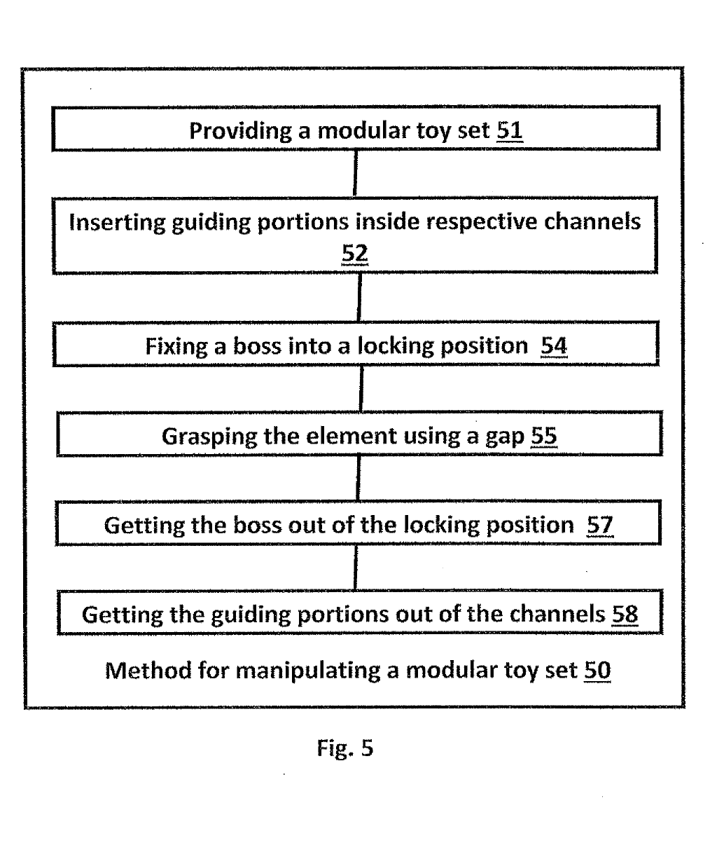

A method 50 for manipulating a modular toy set is presented in the flow chart of FIG. 5. Actually, method 50 is used by players for interaction of an element, two port connector 23 for example, having plugging ports with an article having a receiving port. The method includes a step 51 of providing a modular toy set with building blocks having plugging ports and receiving ports, a step of pushing the article towards the element for connecting the element to the article, and a step of drawing the element apart from the article for disconnecting them. The step of pushing the article towards the element includes a step 52 of inserting two parallel thickened guiding portions 5 of the element into respective two mutually parallel channels 45 such that a flat portion 14 of the plugging port between two parallel thickened guiding portions 5 accommodates a flat space 46 between channels 45. In step 54, pushing further the element to the article causes an elongated boss structure 10 of the plugging port to deflect a flexible locking edge 42 of the receiving port and thus to fixedly accommodate a locking slot 40 inside the receiving port.

The step of drawing apart the element from the article includes a step 55 of grasping the element using a gap 20 in a non plugged plugging port of the element, and a step 57 of causing elongated boss structure 10 to deflect flexible locking edge 42 of the receiving port and thus getting boss 10 out of the locking position at slot 40. Drawing apart the element and the article also causes two parallel thickened guiding portions 5 to get out from the respective channels 45 in step 58, such that flat portion 14 gets out flat space 46.

Thus, method 50 is used to assemble and disassemble the toy set.

### Multiple Port Connectors (FIG. 5-8)

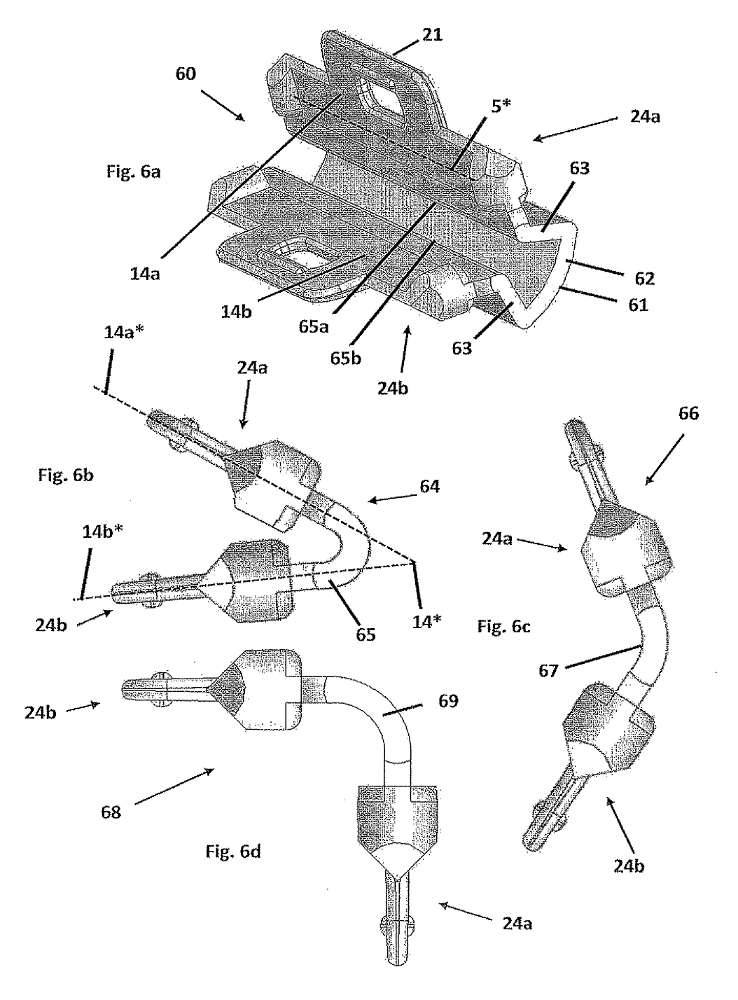

In the embodiments of FIGS. 5-8 a variety of connectors having plugging ports is presented. Each of double port connectors 60, 64, 66 and 68 of respective FIGS. 6a, 6b, 6c, and 6d include plugging ports 24a and 24b having respective flat portions 14a and 14b. Middle (virtual) planes 14a* and 14b* which bisect flat portions 14a and 14b in their shortest dimension and are perpendicular to the drawing sheet, intersect each other along a line 14*. Line 14* is also perpendicular to the drawing sheet, and is parallel to a line 5* which connects the centers of thickened portion 5 of each of plugging ports 24a and 24b, and is also parallel to external border 21.

Plugging ports 24a and 24b of connectors 60, 64, 66 and 68 are connected by respective elongated bridges 61, 65, 67 and 69 with borders along the respective connected flat portions 14a and 14b. Plugging ports 24a and 24b extend outwards and have mutual angular deviation between 40° and 170°. More specifically, in FIGS. 6a and 6b, the angular deviation is between 40° and 60°, in FIG. 6c the angular deviation is between 120° and 160°, and in FIG. 6d it is about 90°.

Plugging ports 24a and 24b of connector 60 are connected by a bridge 61 there between, along parallel respective lines 65a and 65b. In cross-section, bridge 61 has a central are 62 attached to two linear segments 63 in an acute angle of 70° to 85°. Linear segments 63 are attached to flat portions 14a and 14b in an angle of 120° to 160°. Central arc 62 may be a flexible part allowing mutual alignment of the two plugging ports between 180° and 30° and thus provide a lot of versatility. The specific shape of bridge 61 provides a nicely designed radius corner which may be aligned with surfaces of the connected parts.

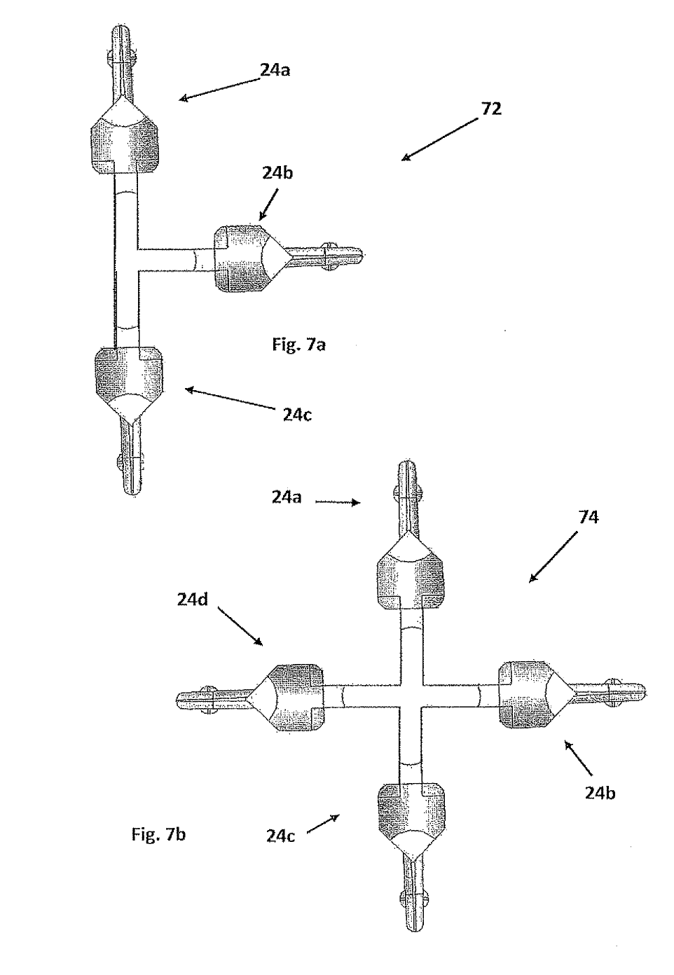

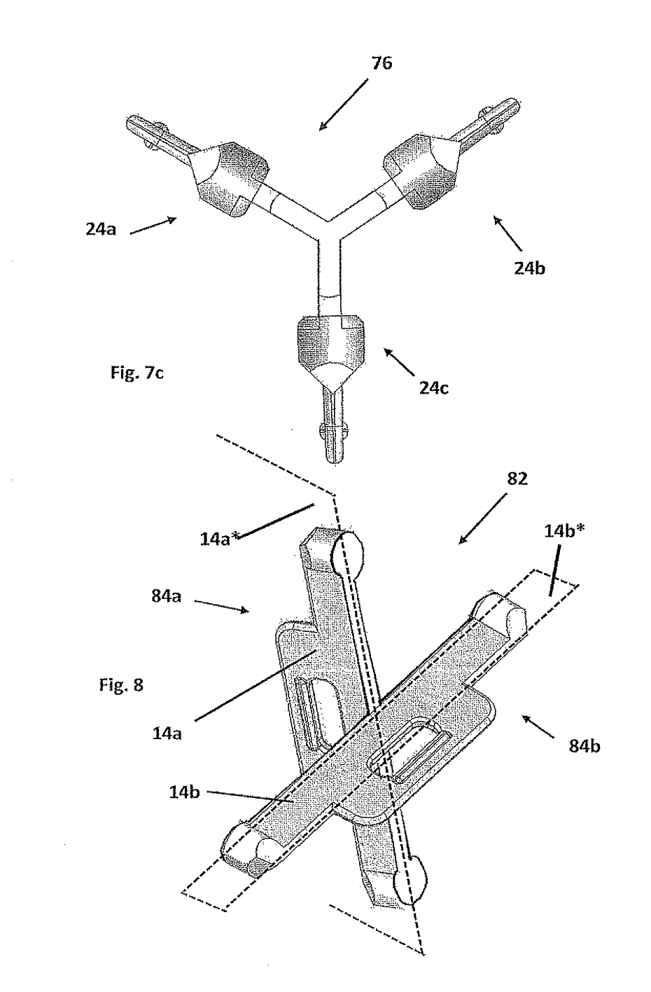

In the embodiments of FIGS. 7a, 7b and 7c, respective connectors 72, 74 and 76 connect three or four plugging ports. Connector 72 is a T-shaped connector having plugging ports 24a, 24b and 24c. Connector 74 is a cross-shaped connector having plugging ports 24a, 24b, 24c and 24d. Plugging ports 24a, 24b and 24c of connector 76 extend outwards with an angle of 120° between each adjacent plugging ports.

Referring now to FIG. 8, a connector 82 has two plugging ports 84a and 84b with respective flat portions 14a and 14b, which are bisected by (virtual) planes 14a* and 14b* in the middle of their short dimension (thickness). Flat portions 14a and 14b may be fixedly connected, or may be connected by a rotatable axis. Flat portions 14a and 14b are aligned or may be aligned such that planes 14a* and 14b* are perpendicular to each other.

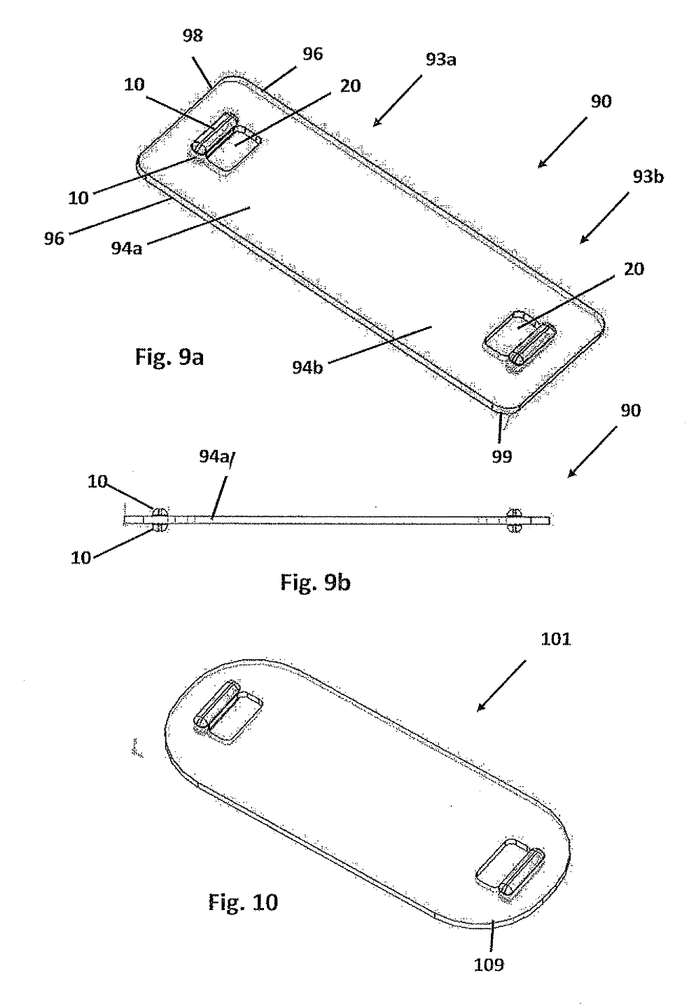

A Multiple Port Connector without Thickened Guiding Portions (FIGS. 9-11)

FIGS. 9-11 illustrate connectors 90, 101, 111 and 120 having several plugging ports for connecting, in a releasable manner, several articles having receiving ports. FIGS. 9a and 9b are respectively a perspective view and a side view of a double port connector 90, having plugging ports 93a and 93b. Plugging ports 93a and 93b include respective flat portions 94a and 94b, elongated boss structures 10, and gaps 20. Each flat portion has two parallel borders 96 and an external border 98 perpendicular to them. Elongated boss structures 10 project outwards both sides of flat portion 94a and extends parallel to external border 98. Gaps 20 are respectively placed within flat portions 94a and 94b, and are configured to facilitate manipulating of plugging ports 93a and 93b.

Plugging port 93a, for example, may be inserted in a receiving portion of an article, such that flat portion 94a accommodates respective groove in the receiving port, and elongated boss 10 is locked into a locking slot therein in a releasable manner.

Comparing now an almost vertical corner 99 of connector 90 with a round corner 109 of connector 101, illustrated in FIG. 10, it is noted that the corner may be curvedly shaped such as the flat portion is slidely inserted into the groove of the receiving port, and is less dangerous to players.

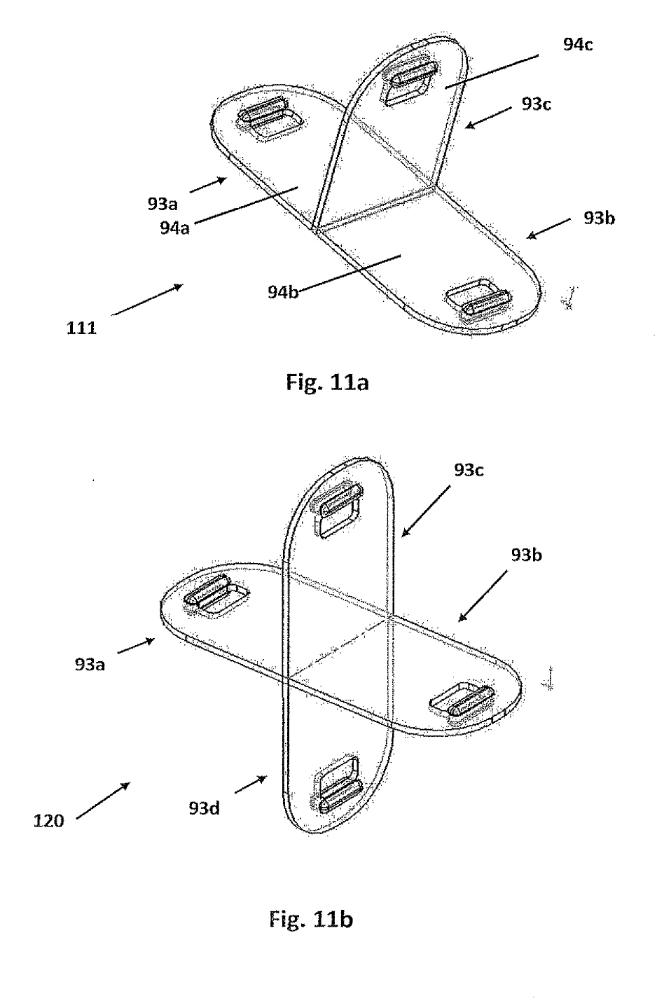

FIGS. 11a and 11b illustrate, respectively, a triple port connector 111 and a four port connector 120. Connector 111 includes plugging ports 93a, 93b and 93c in a T-shaped configuration whereas flat portions 94a and 94b share a common plane, which is perpendicular to plane 94c of plugging port 93c. Similar relations between flat portions are present between the flat portions of connector 120, which is a cross-shaped connector having plugging ports 93a, 93b, 93c and 93d.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. A plugging port for connecting an element to a receiving port of an article in a releasable manner, the plugging port comprising:
(a) a substantially flat portion projected from a body part of the element, the flat portion having two substantially parallel borders of certain length and an external border substantially perpendicular to said two substantially parallel borders;
(b) two thickened guiding portions connected respectively to the two parallel borders, each guiding portion extending substantially parallel to the respective connected border; and
(c) an elongated boss structure projecting from the flat portion and extending substantially parallel to said external border;
wherein the plugging port being inserted in the receiving portion of the article, such that said two thickened guiding portions and at least a major part of said flat portion accommodate respective grooves in said receiving port, and said elongated boss being locked into a locking slot therein in a releasable manner.

2. The plugging port of claim 1 wherein the plugging port further includes:
(d) a gap within said flat portion;
thereby facilitating manipulating of said plugging port.

3. The plugging port of claim 1 wherein said two thickened guiding portions are connected to said flat portion by respective tabs, each tab having a width smaller than the length of said respective connected border.

4. The plugging port of claim 2, wherein thickness of said flat portion at said external border is smaller than thickness of said flat portion in some other place.

5. The plugging port of claim 2, wherein said elongated boss structure has a substantially trimmed radial cross-section extending substantially uniformly from end to end.

6. The plugging port of claim 2, wherein said body part of the element is a connector connecting the plugging port to one or more substantially identical plugging ports.

7. The plugging port of claim 6, wherein said connector connects at least two plugging ports such that the flat portions of said two plugging ports are substantially perpendicular to a common plane.

8. The plugging port of claim 7, wherein said two plugging ports extend outwards in a mutual angular deviation between 40° and 170°.

9. The plugging port of claim 6, wherein said connector connects at least two plugging ports such that their flat portions are mutually perpendicular.

10. The plugging port of claim 6, wherein said connector connects three or four plugging ports.

11. A receiving port for connecting an article to a plugging port of an element in a releasable manner, the receiving port comprising:
(a) two substantially mutually parallel channels, spaced apart and shaped for receiving two thickened guiding portions of the plugging port;
(b) two side slots facing each other in said two substantially mutually parallel channels;
(b) a flat space between the channels for accommodating a flat portion of said plugging port; and
(c) a flexible locking edge for fixing an elongated boss structure of said plugging port in a locking position inside said receiving port,
wherein by applying certain force for drawing apart a plugged plugging port from said receiving port, said locking edge being displaced such as to release said elongated boss structure from said locking position and to let said plugging port getting out said receiving port.

12. An article having two, three or four receiving ports, each receiving port configured in accordance with 11.

13. A method for interaction of an element having at least one plugging port and an article having at least one receiving port, the method comprising:
(a) pushing the article towards the element and thus:
(i) inserting two parallel thickened guiding portions of the element into respective two substantially mutually parallel channels such that a flat portion of said plugging port between said two parallel thickened guiding portions accommodating a flat space between the channels; and
(ii) an elongated boss structure of said plugging port deflecting a flexible locking edge of said receiving port and accommodating a locking position inside said receiving port; and
(b) releasing the article from the element by drawing apart said element from said article and thus:
(iii) said elongated boss structure of said plugging port deflecting said flexible locking edge of said receiving port and getting out of said locking position; and
(iv) said two parallel thickened guiding portions getting out from the respective channels, such that the flat portion of said plugging part getting out said flat space.

14. The method of claim 13 wherein the element includes two plugging ports, each plugging port has a gap within the flat portion between the thickened guiding portions and the method includes a step of grasping the element using a gap.

15. The method of claim 14 wherein the element and the article are respectively a first and a second building blocks of a modular toy set having two or more building blocks, and the method is used to assemble and disassemble the toy set.

16. A connector having two or more plugging ports for connecting in a releasable manner two or more respective articles having each at least one receiving port, each plugging port comprising:
(a) a substantially flat portion having two substantially parallel borders and an external border substantially perpendicular to said two substantially parallel borders;
(b) an elongated boss structure projecting from the flat portion and extending substantially parallel to said external border; and
(c) a gap within said flat portion for facilitating manipulating of said plugging port, wherein the plugging port being inserted in a receiving portion of an article, such that at Least a major part of said flat portion accommodate respective groove in said receiving port, and said elongated boss being locked into a locking slot therein in a releasable manner.

17. The connector of claim 16, wherein said connector connects at least two plugging ports such that the two respective flat portions of said two plugging ports are substantially perpendicular to a common plane.

18. The connector of claim 16, wherein said flat portions are substantially mutually perpendicular.
